(19) United States
(12) Patent Application Publication
(10) Pub. No.: US 2005/0204166 A1
(43) Pub. Date: Sep. 15, 2005

(54) Upgrading password to security tokens

(76) Inventor: Brian Bernard McKeon, Sydney (AU)

Correspondence Address: Brian McKeon, 24 Holdsworth Av, St Leonards, Sydney, 2065, AU

(21) Appl. No.: 11/069,451

(22) Filed: Mar. 2, 2005

(30) Foreign Application Priority Data
Mar. 12, 2004 (AU) 2004901281

(51) Int. Cl. H04L 9/00

(52) U.S. Cl. 713/201

(57) ABSTRACT

This invention allows a provider of a service over a network to upgrade from passwords to security tokens. Tokens are supplied to clients in a generic state and initialised at the client sites, thereby saving the provider the costs of initialisation of tokens for different clients at a central site.

### INTRODUCTION

This invention relates to a system and method for efficient upgrading of password access to information services to use a more secure form of authentication, a hardware token.

### BACKGROUND

Industry is increasingly making use of remote information services for more efficient collation and distribution of information. In many situations, the control of access to different information repositories is required. This raises a requirement that persons requesting access be identified (authenticated).

Many current systems are based on a simple username and password for authentication. This is often acceptable in relatively closed systems such as government or corporate networks where the components are reasonably trusted. However the provision of services over public networks such as the Internet, and often to very varied client computing environments, is a poor environment for the use of passwords.

The ease with which a user password can be stolen by a computer virus or a spoof web page, without user knowledge of the theft, and the high speed with which the password can be subsequently used, is a significant threat to the expansion of services over the Internet or other public networks.

The use of a hardware token such as a smart card is a well-known method to strengthen user authentication. It is still possible to attack such systems but the use of hardware tokens significantly slows any such attacks, allowing other security mechanisms to become effective.

There are many existing password-based services on the Internet however the issuance of hardware tokens is a significant cost for both tokens and administration of upgrades.

### SUMMARY OF THE INVENTION

The present invention describes a method whereby generic tokens can be issued to an existing base of users and the token personalised at the user computer. This significantly reduces costs over personalisation of tokens at a production centre.

An existing user would receive a generic token. This generic token would be able to be verified as a trusted token by the remote service provider.

The user would install the token on their computer and log-on to a network location provided by the service provider. This log-on would be based on the existing user password.

The remote service provider would authenticate the user using the existing password and then open communications with the token and inject data appropriate for that user.

After the token has been verified as correctly personalised, the remote service provider will only allow user authentication based on the token. Further password-based authentication will be disabled.

New users could be issued with tokens that were already personalised with their information. However the above scheme can be extended to new users if the risk of use of a password is acceptable for a short period. This would enable even new users to be issued with generic tokens which would be personalised at their computer.

### DESCRIPTION OF SPECIFIC EMBODIMENTS

The following embodiment is based on a security token that is based on a smart card running the MULTOS [2] operating system and with a proprietary application, AP. This specific embodiment concerns the case where a service provider is providing a service over the Internet to a group of users that are running Microsoft Windows-based computers with Internet Explorer web browsers. The service provider (SP) is running the Apache Web Server (WS) [6] on a Linux operating system. Other embodiments based on different user computing platforms or over different networks or with different service provider systems are obvious to those skilled in the field.

SP will manufacture tokens with generic cryptographic keys confidential to SP and WS. In this instance SP installs an RSA keyset [1] in the token and maintains the token public key in a database indexed by token serial number. Alternative implementations are possible based on a common keyset across a group of tokens or the use of symmetric keysets.

The MULTOS application (MA) provides a standard ISO7816 command/response interface [3,4] which implements the following functions (amongst other functions not directly relevant to this description):

GET CHALLENGE—MA will supply a random challenge and a token serial number to WS in response to a request from WS.

AUTHENTICATE HOST—WS determines the appropriate RSA public key from it's database using the token serial number. It will use this public key to encrypt a response to the above challenge which will initialise a DES3 keyset ([7] p47) within MA. This keyset, CKEY, can be used to maintain confidentiality of further communications between WS and MA. As part of set up of CKEY, WS will have supplied, in the encrypted data, the challenge value from the previous step and MA will verify that the correct challenge value was present before accepting the CKEY.

LOGIN—a user or security officer (SO) can present a command containing a PIN and, if valid, the PIN will unlock the card.

LOAD KEY—loads a user RSA key pair, UKEY, that will be used for user authentication.

LOAD DATA—an X509V3 certificate is loaded. This certificate will be used for user authentication.

CLOSE CONFIDENTIAL COMMUNICATIONS—in this implementation this is achieved by reselecting the card application.

SP has configured WS so that certain web pages or websites would require client-authentication for access. This would be password-based. The same pages or websites can also be accessed via client-authenticated SSL ([5] p40-43).

SP provides certain webpages to allow a user to upgrade their password access to token-based access. This page itself would require password access. The user would logon to this page which would activate a custom application on the user computer. This custom application would connect to WS and initiate the sequence of GET CHALLENGE, AUTHENTICATE HOST and LOGIN as described above. WS would then generate a user keyset (UKEY) and an X509 certificate for that user. The LOAD KEY, LOAD DATA, and CLOSE CONFIDENTIAL COMMUNICATIONS would then load the keyset and certificate to the token. If successful, this upgrade process would be disabled for this user to prevent a user from initialising a number of tokens.

If the token was successful initialised WS would then remove the user from the password-based access method and add the new X509 certificate to the client-authenticated SSL access. The user will then have to use the token for further access and will not be able to use the previous password. The relevant part of the client-authenticated SSL access is the presentation of a challenge value to the token which is then signed by UKEY and returned to WS. WS can then verify the challenge with the public key relevant to the user attempting access. In this implementation WS maintains a directory of X509 certificates of users that are allowed access. In this way a user with a token can be denied access by removing their certificate from the directory. Other variations on access methods are possible with client-authenticated SSL (see [6]).

In this embodiment, once the password upgrade program has been initiated, WS provides a time period after which password access will be removed. Users are expected to have upgraded to token access within that time period and are warned by WS about this time requirement each time they login using a password.

In the present embodiment, new users are supplied with generic tokens and passwords rather than pre-personalised tokens. This makes the process more regular. However the password for a new user will only allow access to the certain webpages that allow upgrade of password access to token access. Only after the token has been personalised, can the token be used to access any other restricted webpages.

If a token is lost or stolen then SP is to be notified and the existing X509 certificate is removed from the relevant WS directory, thereby disabling the token. SP will then provide the user with a new token and a password. The user is provided with password authentication for a predetermined period during which they are expected to upgrade their token.

Although the invention has been described with reference to specific embodiments of the invention, it will be appreciated by those skilled in the art that it may be embodied in many other forms.

### REFERENCES

[1] Digital Signatures, Atreya et al, RSA Press, 2002

[2] MULTOS Smart Card Operating System, ref www.multos.com

[3] ISO7816-3, Identification Cards—Integrated Circuit(s) Cards with Contacts—Electronic Signals and Transmission Protocols

[4] ISO7816-4, Identification Cards—Integrated Circuit(s) Cards with Contacts—Interindustry Commands for Interchange

[5] Web Security, Stein, 1998, ISBN 0-201-63489-9

[6] Apache Web Server, ref www.apache.org

[7] RSA Security's Official Guide to Cryptography, Burnett & Paine, RSA Press, 2001, ISBN 0-07-213139-X

1. A method for allowing a username and authentication password of a computer user to initiate the personalisation of a non-personalised security token, to be personalised for that user, over a network, and the subsequent use of that security token as the authentication mechanism for that user.

2. A computer system based on the method of 1.

3. A computer system based on the method of claim 1 where the security token is a hardware token such as a USB token or a smartcard.

4. A method based on claim 1 where authentication of a user by password is disabled once the authentication token has been enabled.

5. A computer system based on the method of 4.

6. A computer system based on the method of claim 5 where the security token is a hardware token such as a USB token or a smartcard.
